(19) United States
(12) Patent Application Publication
(10) Pub. No.: US 2022/0211231 A1
(43) Pub. Date: Jul. 7, 2022

(54) NOISE REDUCTION DEVICE

(71) Applicant: KONINKLIJKE PHILIPS N.V., EINDHOVEN (NL)

(72) Inventors: Michael Van Den Bosch, EINDHOVEN (NL); Albert Al-Shorachi, EINDHOVEN (NL)

(73) Assignee: KONINKLIJKE PHILIPS N.V., EINDHOVEN (NL)

(21) Appl. No.: 17/611,151

(22) PCT Filed: May 6, 2020
(86) PCT No.: PCT/EP2020/062481

§ 371 Date: Nov. 14, 2021

(30) Foreign Application Priority Data
May 14, 2019 (EP) 19174530.6

(51) Int. Cl. A47L 9/00; G10K 11/16

(52) U.S. Cl. CPC A47L 9/0081; G10K 11/161

(57) ABSTRACT

A noise reduction device includes a main tube having a first pass-through area where a fluid enters the main tube, and a side-branch connected to the main tube. The main tube includes a narrowed section having a second pass-through area that is at least 25% (preferably, at least 50%, and more preferably, at least 60%) smaller than the first pass-through area, and the side-branch is connected to the narrowed section of the main tube. Where the side-branch is connected to the main tube, the side-branch is preferably sealed-off by a cover that is acoustically transparent, which may be impermeable for the fluid. Such a noise reduction device is advantageously used in a fluid displacing appliance (e.g. a vacuum cleaner), including a motor for displacing the fluid (e.g. gas or liquid).

### FIELD OF THE INVENTION

The invention relates to a noise reduction device for use in various appliances, like vacuum cleaners and other appliances with displace fluids (could be air, water or other fluids) where pressure pulses are generated that travel through conduits/pipes/tubing, such as hair dryers, hair stylers with fan, air cleaners, air humidifiers, air conditioning devices, coffee machines, ironing devices, respiratory support devices, breast pumps, etc. The invention also relates to such an appliance provided with a noise reduction device.

### BACKGROUND OF THE INVENTION

U.S. Pat. No. 6,450,289 discloses a noise attenuation device having an array of quarter wave resonators which have varying mouth widths disposed adjacent an aperture or ventilation opening having a predefined width. The resonators are tuned to a resonant frequency, increasing from one face of the attenuation device to another, and so that the mouth widths are each greater than the width of the aperture or ventilation opening, respectively. Optionally, a second array tuned to a different frequency may be disposed on the opposite side of the aperture and the aperture may be kinked so that there is no direct line of sight through the device.

The article “Narrow sidebranch arrays for low frequency duct noise control” by S. K. Tang, J. Acoust. Soc. Am. 132 (5), November 2012, investigates the sound transmission loss across a section of an infinitely long duct where one or more narrow sidebranch tubes are installed flushed with the duct wall. Broadband performance of the device can be greatly enhanced by appropriate arrangements of tube lengths and/or by coupling arrays on the two sides of the duct.

### SUMMARY OF THE INVENTION

It is, inter alia, an object of the invention to provide an improved noise reduction device. The invention is defined by the independent claims. Advantageous embodiments are defined in the dependent claims.

According to a first aspect of the invention, in a noise reduction device, comprising a main tube having a first pass-through area where a fluid enters the main tube, and a side-branch connected to the main tube, the main tube comprises a narrowed section having a second pass-through area that is at least 25% (preferably, at least 50%, and more preferably, at least 60%, such as 75%) smaller than the first pass-through area, and the side-branch is connected to the narrowed section of the main tube. Where the side-branch is connected to the main tube, the side-branch is preferably sealed-off by a cover that is acoustically transparent, and which may be impermeable for the fluid.

A second aspect of the invention provides a noise reduction device, comprising a main tube having a first pass-through area where a fluid enters the main tube, and a side-branch connected to the main tube, in which where the side-branch is connected to the main tube, the side-branch is sealed-off by a cover that is acoustically transparent, and which may be impermeable for the fluid.

Such noise reduction devices are advantageously used in a fluid displacing appliance (e.g. a vacuum cleaner), comprising a motor for displacing a fluid (e.g. gas or liquid).

The first aspect of the invention is based on the recognition that while quarter wave tubes can be an effective noise reduction tool, use of such a tool takes a lot of additional space, which is often not available. The inventors have recognized that the same noise reduction can also be obtained when a pass-through area of a main tube to which side-branches are coupled is narrowed, while such narrowing allows for an easier way to integrate the noise reduction device into the appliance that should produce less noise, such as a vacuum cleaner. For example, if the pass-through area of the main tube is reduced by 25%, the entire noise reduction device is made 25% smaller. More significant advantages can be obtained if the pass-through area is reduced by 50%, 60% or 75%. However, the narrower the pass-through area of the main tube of the noise reduction device, the more resistance is posed to the liquid passing the main tube, which may result in that for e.g. a particular battery-operated vacuum cleaner, the pass-through area is preferably reduced by about 60%, while for a mains-operated vacuum cleaner, the pass-through area may be reduced by 75% or more. A reduction of the pass-through area is preferably carried out gradually, e.g. at an angle in a range of about 18°-26°, e.g. 20°, when the main tube is narrowed, and at an angle in a range of about 7°-10°, e.g. 9.5°, when the main tube is broadened again.

As regards the one or more side-branches, it holds that if they have the same area as the main tube, they can 100% cancel a particular frequency. The inventors have, however, realized that there is often no need to completely cancel a particular frequency, but a need to sufficiently cancel a frequency range by e.g. 10 dB. For that purpose, it suffices to have multiple side-branches tuned to different frequencies in the frequency range in which the noise is to be reduced, with each side-branch having an area that is e.g. 25% of the pass-through area of the main tube. When, as explained above, the pass-through area of the main tube is reduced by at least 25%, so that the side-branches are made smaller both by the same factor (as for a 100% cancellation, it suffices that the side-branch has the same area as the main tube), and by e.g. 75% which suffices to get a 10 dB reduction in the desired frequency range. It is noted that what matters is the total area of side-branches tuned to a particular frequency and at the same distance of the beginning of the main tube, so that the respective areas of a plurality of side-branches tuned to a same frequency can be summed. However, if in the flow direction in the main tube, 2 side-branches each having 50% of the area of the main tube (and thus only cancelling 50% of the noise at a particular frequency) and tuned to a same frequency are positioned behind each other, the total noise cancellation at that frequency is not 100% but 50%+(50% of the remaining 50%)=75%.

To ensure that the liquid passes the main tube without undesired turbulences, which may result in additional resistance and/or undesired noise generation, the side-branches are preferably sealed-off, at their respective connections to the main tube, by a cover (e.g. a foil, membrane or mesh) that is acoustically transparent but impermeable for the liquid flowing through the main tube. Herein, “acoustically transparent” does not need to be fully acoustically transparent; what matters is that the side-branch is still able to function as a quarter wave tube in a meaningful manner. Also, “impermeable” does not need to be fully impermeable; what matters is that the fluid is able to pass the main tube without meaningful disturbances. In the context of a system that does not allow dirt, which could enter the side branch, enter the noise reduction device, it suffices that the cover is acoustically transparent while it yet makes the side-branches “invisible” for the liquid that passes the main tube, thereby preventing undesired turbulences from occurring, as such undesired turbulences may result in additional resistance and/or undesired noise generation.

These and other aspects of the invention will be apparent from and elucidated with reference to the embodiments described hereinafter.

### BRIEF DESCRIPTION OF THE DRAWINGS

FIG. 1 shows a cross-section of a main tube of an embodiment of a noise reduction device in accordance with the present invention;

FIG. 2 shows several side-branches connected to a narrowed section of the main tube of FIG. 1;

FIG. 3 illustrates a connection of a side-branch to a main tube of a preferred embodiment of a noise reduction device in accordance with the present invention;

FIG. 4 illustrates how a single quarter wave tube can reduce noise by 10 dB over a certain bandwidth; and

FIG. 5 illustrates how 8 single quarter wave tubes can reduce noise by 10 dB over a certain bandwidth.

### DESCRIPTION OF EMBODIMENTS

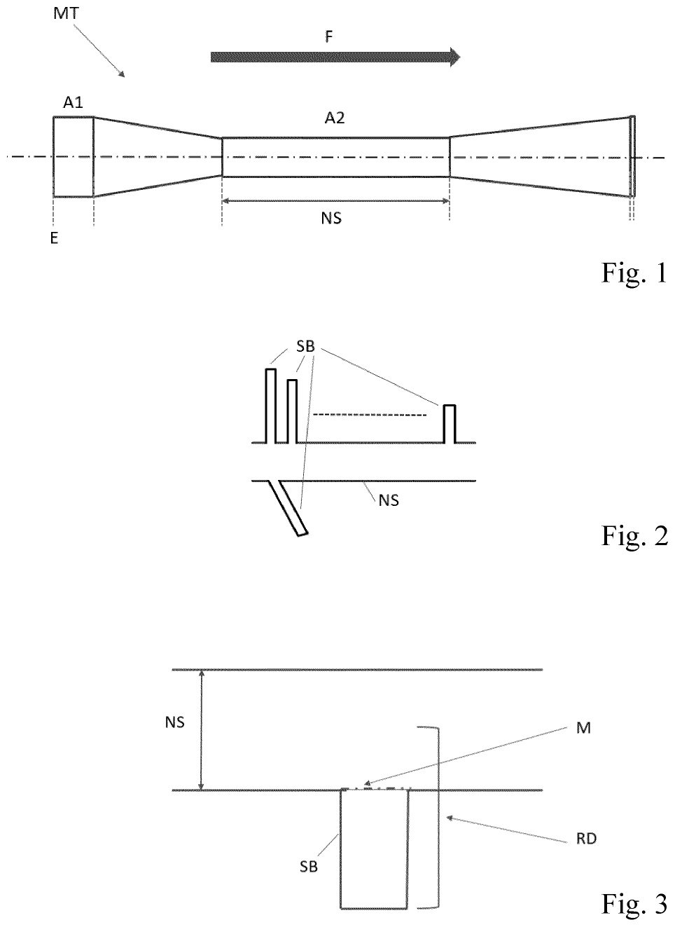

FIG. 1 shows a cross-section of a main tube MT of an embodiment of a noise reduction device in accordance with the present invention. A flow direction F of a fluid (liquid, gas) is indicated by an arrow. At an entrance E of the main tube MT, a pass-through area A1 is indicated. The main tube MT has a narrowed section NS, which has a pass-through area A2<A1.

FIG. 2 shows several side-branches SB connected to the narrowed section NS of the main tube MT of FIG. 1. The side-branches SB have mutually different lengths so as to be tuned to mutually different frequencies of the noise to be reduced. The side-branches SB may be perpendicular to the narrowed section, or at a different angle. The various side-branches SB do not need to have identical widths. The main tube and the various side-branches do not need to have round pass-through areas, so that e.g. a square or oval shape is possible, and they may be curved rather than straight. In this way, it is possible to “hide” the noise reduction device within limited available space imposed by the design of the appliance in which the noise reduction device is to be applied.

FIG. 3 illustrates a connection of a side-branch SB to the narrowed section NS of the main tube MT of a preferred embodiment of a noise reduction device in accordance with the present invention. A membrane structure M covers the entire opening of the side branch SB. Doing so results in 2 advantages: the fluid flow through the main tube MT is not disturbed by turbulences caused by the presence of the side-branches SB, and the side-branches SB do not collect any dirt that may be present in the fluid, thereby losing their effectiveness as regards noise cancellation. It is advantageous to keep the impedance of the membrane M as low as possible to reach maximum noise cancellation properties. To that end, the membrane M should be thin, having a thickness that is preferably below 0.1 mm, and preferably in the order of magnitude of 0.01 mm, such as provided by plastic used for plastic food bags. A mesh having small holes (e.g. 0.3 mm) appeared to do well as regards not diminishing noise reduction too much, but less well as regards mitigating turbulences in the main tube. This aspect of the invention could also be used in a noise reduction device in which the at least one side-branch is connected to a main tube that is not narrowed.

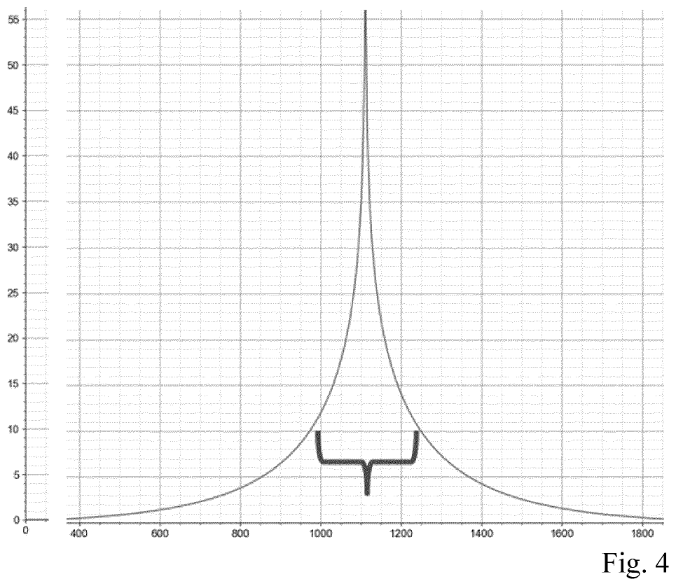

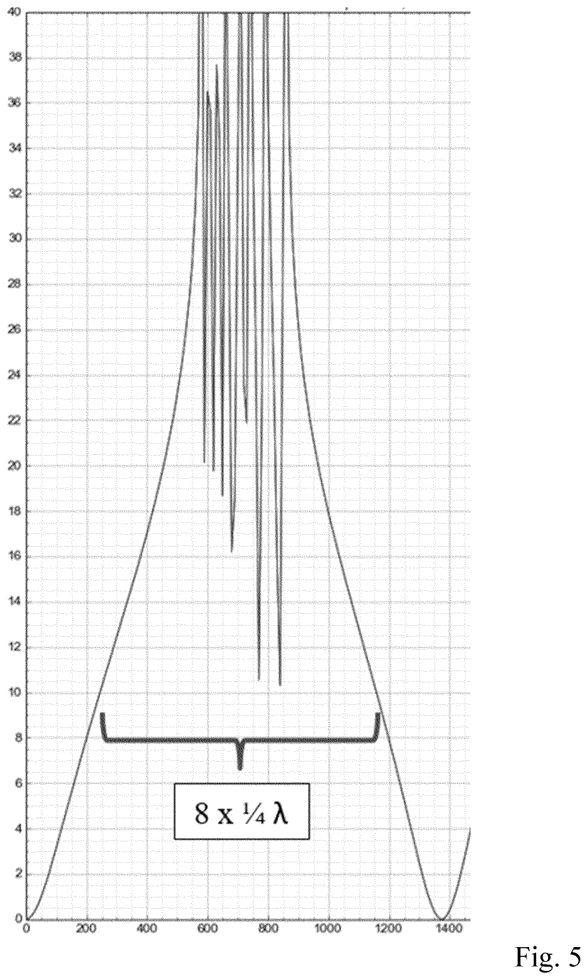

FIG. 4 illustrates that a single quarter wave tube tuned to a frequency of about 1100 Hz can reduce noise by 10 dB over a bandwidth of almost 300 Hz (so from about 950 Hz to about 1250 Hz). The horizontal axis shows the frequency in Hz, while the vertical axis shows the noise reduction in dB. FIG. 5 illustrates that 8 single quarter wave tubes tuned to mutually different noise reduction frequencies can together reduce noise by 10 dB over a bandwidth of about 900 Hz (from about 250 Hz to about 1150 Hz). For this purpose, the side-branches SB may have a smaller cross-section area than the pass-through area A2 of the narrowed section NS of the main tube MT. While not shown in FIGS. 4 and 5, the quarter wave tubes also result in noise reduction at odd multiples of the noise reduction frequencies to which they are tuned.

It should be noted that the above-mentioned embodiments illustrate rather than limit the invention, and that those skilled in the art will be able to design many alternative embodiments without departing from the scope of the appended claims. For example, instead of side-branches that are adjacent to one another, side-branches may be nested, i.e. concentric. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention may be implemented by means of hardware comprising several distinct elements. In the device claim enumerating several means, several of these means may be embodied by one and the same item of hardware. Measures recited in mutually different dependent claims may advantageously be used in combination.

1. A noise reduction device, comprising:
a main tube having a first pass-through area where a fluid enters the main tube; and
a side-branch connected to the main tube, wherein the main tube comprises a narrowed section having a second pass-through area that is at least 25% smaller than the first pass-through area, the side-branch being connected to the narrowed section of the main tube.

2. The noise reduction device as claimed in claim 1, wherein the second pass-through area is at least 50% smaller than the first pass-through area.

3. The noise reduction device as claimed in claim 2, wherein the second pass-through area is at least 60% smaller than the first pass-through area.

4. The noise reduction device as claimed in claim 1, wherein the side-branch is connected to the main tube, the side-branch is sealed-off by a cover that is acoustically transparent.

5. The noise reduction device as claimed in claim 4, wherein the cover is impermeable for the fluid.

6. A fluid displacing appliance, comprising:
a motor for displacing a fluid, and
a noise reduction device comprising:
a main tube having a first pass-through area where a fluid enters the main tube; and
a side-branch connected to the main tube, wherein the main tube comprises a narrowed section having a second pass-through area that is at least 25% smaller than the first pass-through area, the side-branch being connected to the narrowed section of the main tube.

7. The fluid displacing appliance as claimed in claim 6, wherein the side-branch is connected to the narrowed section perpendicularly.

8. The fluid displacing appliance as claimed in claim 6, wherein the side-branch is connected to the main tube, the side-branch is sealed-off by a cover that is acoustically transparent.

9. The fluid displacing appliance as claimed in claim 8, wherein a thickness of the cover is in an order of magnitude of 0.01 mm.

10. The fluid displacing appliance as claimed in claim 8, wherein the cover is impermeable for the fluid.

11. The fluid displacing appliance as claimed in claim 6, wherein the second pass-through area is at least 50% smaller than the first pass-through area.

12. The fluid displacing appliance as claimed in claim 6, wherein the second pass-through area is at least 60% smaller than the first pass-through area.

13. The fluid displacing appliance as claimed in claim 6, wherein the fluid displacing appliance is a vacuum cleaner.
